(19) United States
(12) Patent Application Publication
(10) Pub. No.: US 2009/0006245 A1
(43) Pub. Date: Jan. 1, 2009

(54) Method and system for administering linked loans

(76) Inventor: Jeremy Rabson, Newton, MA (US)

Correspondence Address: Kevin M. Farrell;Pierce Atwood, Suite 350, One New Hampshire Avenue, Portsmouth, NH, 03801, US

(21) Appl. No.: 11/821,910

(22) Filed: Jun. 26, 2007

(51) Int. Cl. G06Q 40/00

(52) U.S. Cl. 705/38

(57) ABSTRACT

In one embodiment, the present invention comprises a method of managing more than one loan agreement pertaining to a single loaned sum repayable in one or more scheduled installment amounts comprising providing a first loan agreement and a second loan agreement and administering the two. The first loan agreement exists between a primary borrower and the loan originator and comprises a first set of terms by which the primary borrower makes first tier payments in repayment of the loaned sum. The second loan agreement exists between the primary borrower and a secondary borrower and comprises a second set of terms by which the secondary borrower makes second tier payments to the loan originator in repayment of the loaned sum obtained by the primary borrower and loaned by the primary borrower to the secondary borrower.

### BACKGROUND OF THE INVENTION

1. Field of the Invention

The present invention relates generally to the field of administering a loan repaid by more than one party and more particularly, this invention relates to managing more than one loan agreement pertaining to a single loaned sum repayable in one or more scheduled installment amounts.

2. Discussion of Background Information

Financial institutions often make a monetary loan to more than one borrower based on the borrowers' collective ability to repay the loaned sum. Typically, these scenarios involve each borrower having a preferred credit rating. Often one or both borrowers must retain sufficient collateral such that each party is capable of substantiating the other party's debt owed in the instance of an incomplete payment. In another common multiple borrower scenario, one party wishing to borrow money may lack the credit history, credit rating, or any collateral for qualifying for a loan, and, in order to obtain a loan, a guarantor must assume responsibility for satisfying any outstanding debt not paid by the borrower. This later type of loan arrangement often arises, for example, in the context of a first time home buyer obtaining a mortgage or a student obtaining a tuition loan wherein a responsible second party, such as a parent, guarantees repayment of the loan.

In this later example, college students often have insufficient credit history, savings and collateral to qualify for a loan substantial enough to pay tuition bills and education related expenses. Parents typically apply or cosign for a loan on behalf of their children. Upon graduation, the children repay either their parents or the loan originator depending on the type of loan ascertained by the parent and depending on the loan repayment terms. If a child falls short on payments to a financial institution collecting payments on that loaned sum, the parent or child's credit may be affected by that failure, and the parent child relationship may suffer. Additionally, many federally guaranteed student loans, such as the Federal Stafford Loan, the Federal Perkins Loan and the Parent Loan for Undergraduate Students (PLUS), often incur a higher interest rate than other types of loans, and typically, interest on these education loans begins to accrue from the date of disbursement.

Instead of selecting one or more of these standard education loans, sometimes parents will apply for a loan having more favorable repayment terms, for example a home equity loan, and then pass on the proceeds of that loan, which incurs a lower rate of interest than a traditional federally guaranteed or private student loan, to their child for funding the child's tuition. The child is then in an awkward position of owing money to his own parents, which debt typically is unaccompanied by any formalized mechanism for repayment. The child incurs an emotional burden of having to repay his parents in addition to the financial burden of repaying the debt. Parents, in turn, run the risk of inconsistently receiving payments and maybe receiving no interest on any payments. A parent's asking a child to repay money may damage that parent's relationship with that child, and a child's failing to repay a parent also may damage their relationship and/or their credit rating.

Despite this relationship risk, a parent-child relationship innately comprises a connection between those two parties that typically motivates both sides to perform. Loaning money to a child may be a natural occurrence for a parent and wanting to repay a debt owed to a parent may be a natural instinct for the child. Such a connection fails to exist inherently in other types of non-institution-to-person loan arrangements, such as that between a small business and a person. Without an inherent, instinctual motivation for repayment and without a formalized method for administering repayment, a borrower may be less motivated to repay a small business from which a loan is made. In case of default, the business will lose assets, and the small business could elect to take legal action, thereby tarnishing the borrower's credit.

In addition to the risk of damaging personal relationships or damaging credit, loaning money to a financially needy individual requires an understanding of that individual's timeline for having sufficient and consistent income with which to repay the loan. For example, a college student's ability to repay their parent for loaned tuition depends on that student's ability to procure employment. A parent thus may desire to receive payment installments from a child that bear different principal amounts and interest rates than those required of the parent by the originating financial institution. Additionally, a parent may desire to provide some flexibility to their child who may have a higher income and better ability to repay a loan after some substantial period of time following graduation. Typically, a college loan agreement requires that a child repay that loaned sum in even installments immediately upon graduation. Deferral techniques may provide some relief for an unemployed graduate. The emotional weight of an outstanding debt, however, still exists for the borrowing graduate and that burden may intensify in the absence of any option for ameliorating a rate of repayment and lessening a recent graduate's immediate burden.

For these reasons, a need exists for a manageable and operationally efficient system and method by which a financially established party may obtain an institution loan at a relatively low rate and pass along the loan proceeds to a financially needy party who will benefit ultimately from that rate of repayment. Additionally, a need exists for a mechanism of managing non-institution loans linked to these institution loans and payable in installments at unique and potentially variable rates and/or repayment terms that better reflect and protect the nature of a relationship between a financially established party and a financially needy party.

### SUMMARY OF THE INVENTION

The present invention is directed to an improved method of managing more than one loan agreement pertaining to a single loaned sum repayable in one or more scheduled installment amounts.

In one embodiment of a method of the present invention, the management of more than one loan agreement pertaining to a single loaned sum repayable in one or more scheduled installment amounts comprises providing a first loan agreement and a second loan agreement and administering the two. The first loan agreement exists between a primary borrower and the loan originator and comprises a first set of terms by which the primary borrower makes first tier payments in repayment of the loaned sum, wherein each first tier payment may comprise all or part of the one or more scheduled installment amounts. The second loan agreement exists between the primary borrower and a secondary borrower and comprises a second set of terms by which the secondary borrower makes second tier payments to the loan originator and/or an escrow account held by the loan originator on behalf of the primary borrower in repayment of the loaned sum obtained by the primary borrower and loaned by the primary borrower to the secondary borrower in accordance with the second set of terms.

The second tier payments may differ in amount from the first tier payments. The second set of terms may vary from the first set of terms, and the second tier payments may comprise all or part of the one or more scheduled installment amounts. The method further comprises loaning the loaned sum to the primary borrower based on the primary borrower's qualifications, administering the first loan agreement and receipt of any first tier payments, administering the second loan agreement and receipt of any second tier payments, reconciling received first tier payments and second tier payments together against each corresponding one or more scheduled installment amounts, and administering any payment deficiency or overpayment of the one or more scheduled installment amounts in accordance with one or more remedies defined within the first set of terms and/or the second set of terms.

In an embodiment of a computer implemented method of the present invention, the management of at least two distinct loan agreements pertaining to repayment of a single institutional loan comprises providing an organization terminal connected to a computer network, wherein the organization terminal comprises a memory portion and a processor portion and wherein the memory portion contains therein a software portion executable by the processor. The software portion further comprises a first series of executable instructions based on a first set of terms that structures one or more first tier repayments within a first loan agreement between a first party and a financial institution and a second series of executable instructions based on a second set of terms that structures one or more second tier repayments within a second loan agreement between a second party and the first party. The second tier payments may differ in amount from the first tier payments. The second set of terms also may vary from the first set of terms, and the second tier payments may comprise all or part of the one or more scheduled repayment installments. The software portion also may comprise a third series of executable instructions based on a third set of terms established for managing any overpayment or underpayment of any scheduled repayment installment.

The computer implemented method further comprises providing a registry stored in the memory portion that retains an account balance for a self balancing account linking the two distinct loan agreements, and executing the software portion in response to any first and second tier repayments received by the financial institution from both the first party and the second party. The method then comprises updating the self balancing account according to any payment received by the financial institution in accordance with the first loan agreement and the second loan agreement, reconciling any combined first tier repayment and the second tier repayment against a scheduled repayment installment, and administering any overpayment or underpayment of the scheduled repayment installment according to the third set of terms.

In an embodiment of the system of the present invention, management of a single institutional loan originating from a financial institution, comprises an organization terminal connected to a computer network, wherein the organization terminal comprises a memory portion and a processor portion and wherein the memory portion contains therein a software portion executable by the processor in response to any payments received by the financial institution from at least two parties repaying the single institutional loan. The system further comprises a registry stored in the memory portion that retains an account balance for a single institutional loan repayable by the at least two parties in one or more scheduled repayment installments.

A first loan agreement exists between a first party and the financial institution that structures first payments to the financial institution in accordance with the one or more scheduled repayment installments and according to a first set of terms that defines a first series of executable instructions within the software portion, wherein the first payments may comprise all or part of a scheduled installment amount. A second loan agreement exists between a second party and the first party that structures second payments to the financial institution on behalf of the first party, in accordance with the one or more scheduled repayment installments, and in accordance with a second set of terms that defines a second series of executable instructions within the software portion, wherein the second payments may differ in amount from the first payments, wherein the second set of terms may vary from the first set of terms, and wherein the second payments may comprise all or part of a scheduled installment amount. A third set of terms that defines a third series of executable instructions within the software portion for managing any overpayment amount or underpayment amount of any scheduled repayment installment pertaining to repayment of the single institutional loan.

### BRIEF DESCRIPTION OF THE DRAWINGS

FIG. 1 is a schematic showing an overview of an embodiment of a system according to the present invention.

FIG. 2 is a schematic showing an embodiment of a method of the present invention.

FIG. 3 is a schematic showing an embodiment of a computer system for implementing the present invention.

FIG. 4 is a schematic showing an embodiment of a computer implemented method of the present invention.

### DETAILED DESCRIPTION

The present invention resolves the stated deficiencies of typical loan systems, and provides an improved method and system of managing more than one loan agreement pertaining to a single loaned sum repayable in one or more scheduled installment amounts.

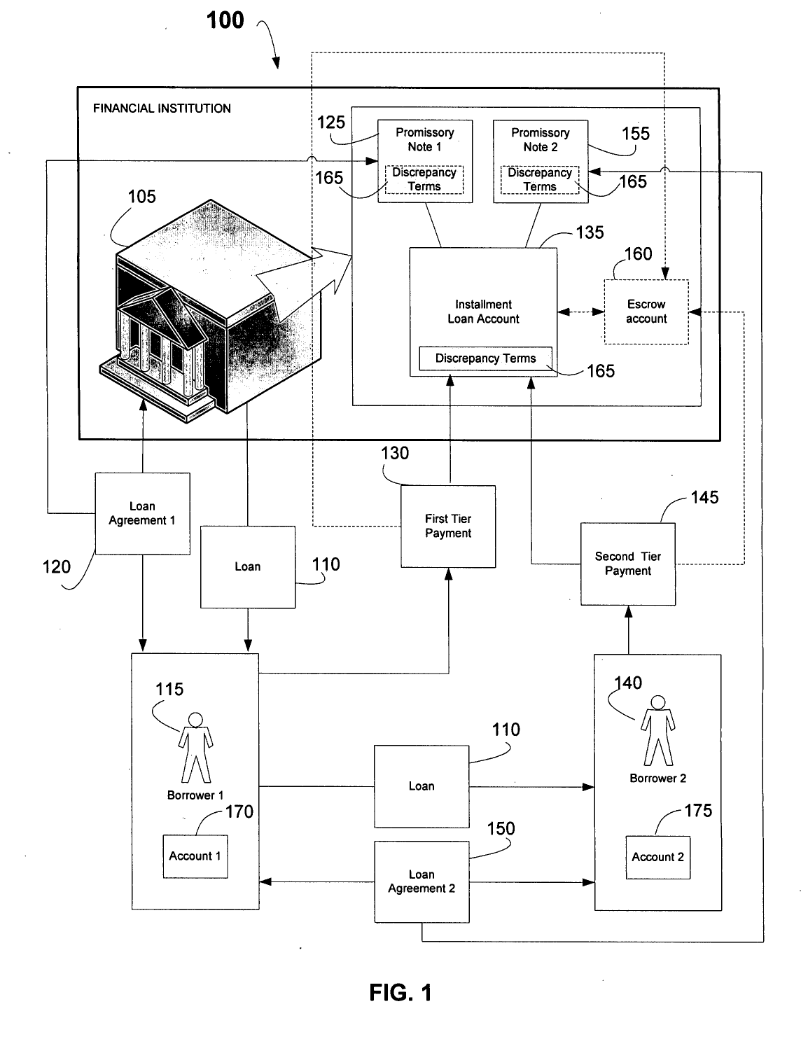

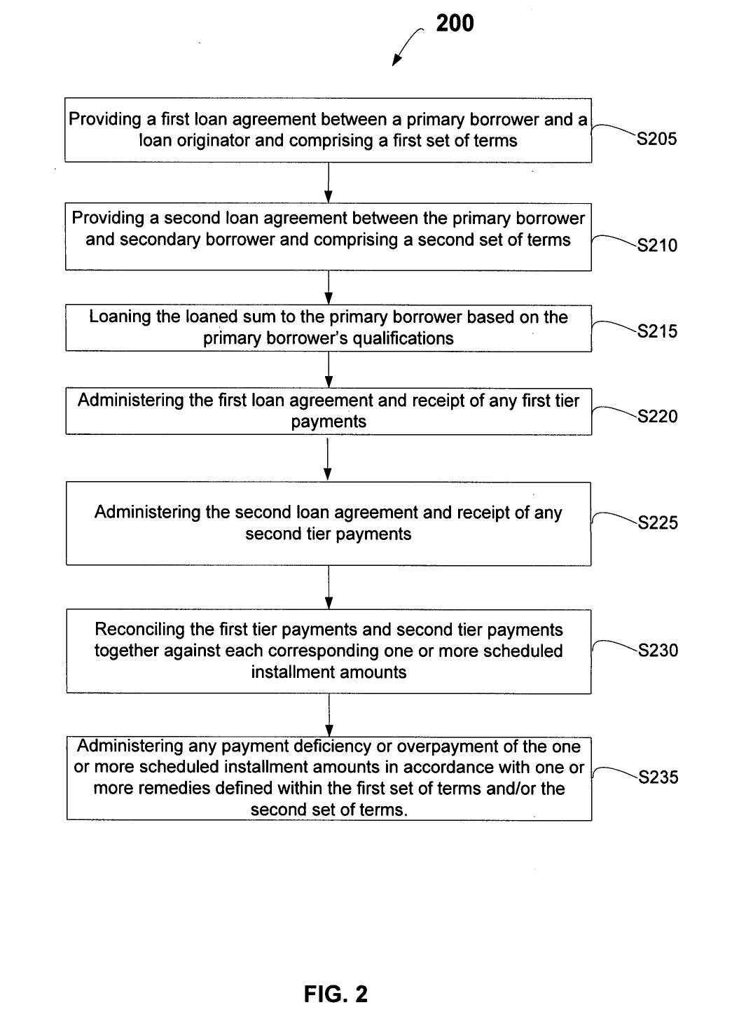

Taken together, FIGS. 1 and 2 depict an overview of one embodiment of the loan management system 100 and loan management method 200 of the present invention for managing more than one loan agreement pertaining to repayment of a single loaned sum. The loan management system 100 includes a financial institution 105 that operates as a loan originator for providing a loan 110 to a primary borrower 115. As indicated in a first step S205 of the embodiment of the loan management method 200 depicted in FIG. 2, the financial institution 105 and the primary borrower 115 enter into a first loan agreement 120 comprising a first set of terms 125 for repayment, which are represented in FIG. 1 as promissory note 1. Promissory notes typically represent a contractual promise to honor terms and conditions of repaying a borrowed sum of money. A promissory note therefore may embody the first set of terms 125 and may comprise elements such as but not limited to a capital amount owed, a variable or fixed interest rate, a note maturity date, any default provisions and an installment payment structure. The installment payment structure may comprise one or more installment amounts requiring payment in accordance with a schedule. The primary borrower 115 may be a person or business, such as a small business, and the first set of terms 125 thus may represent an institution-to-person loan agreement or an institution-to-business loan agreement.

The financial institution 105 retains this first set of terms 125 that structures repayment of the loan 110 by the primary borrower 115, and administers the first loan agreement 120 by collecting one or more first tier payments 130 from the primary borrower 115 in partial or complete satisfaction of one or more known installment payment amounts specified within the first set of terms 125. In one embodiment, the primary borrower 115 directs these first tier payments 130 to a loan account 135 at the financial institution 105. In one embodiment, this loan account 135 is an installment loan account whereby borrowed money is returned in installments of principal typically combined with interest. Each first tier payment 130 may comprise all or part of each installment payment amount depending on whether the loan account 135 also receives payments from a secondary borrower 140 making one or more second tier payments 145 on the loan 110.

The secondary borrower 140 makes those second tier payments 145 according to a second loan agreement 150 that comprises a second set of terms 155 for repayment, which are represented in FIG. 1 as promissory note 2. Providing this second loan agreement 150 and second set of terms 155 occurs at a second step S210 in the embodiment of the loan management method 200 shown in FIG. 2. At this second step S210, the primary borrower 115 lends proceeds of the loan 110 to the secondary borrower 140, and the second loan agreement 150 establishes repayment of the loan 110 by the secondary borrower 140. Thus, two loan agreements 120, 150 exist with regard to a single loan 110 originating from the financial institution 105. The secondary borrower 140 may be a person and second loan agreement 150 may represent a non-institution loan agreement such as a person-to-person loan agreement or a business-to-person loan agreement.

Next, at a third step S215 in the loan management method 200, the financial institution 105 grants the loan 110 based on qualifications of the primary borrower 115. The primary borrower 115 may have superior credit standing and may possess substantial collateral as compared to the secondary borrower 140. The primary borrower 115 thus may qualify for a superior type of loan 110 comprising benefits such as but not limited to highly favorable repayment terms and interest rates. These benefits otherwise would remain unavailable to the secondary borrower 140 who would qualify only for a less favorable loan 110. The primary borrower 115 then passes along the benefit of this superior loan 110 to the secondary borrower 140 and they establish between themselves a second loan agreement 150 independent of any input or influence from the financial institution 105. This enables the primary borrower 115 to establish independent repayment terms favorable to the secondary borrower 140, with whom the primary borrower 115 may have a unique personal or business relationship, such as a parental relationship or business partnership.

In a fourth step S220 of the embodiment of the loan management method 200 of the present invention depicted in FIG. 2, the financial institution 105 administers the first loan agreement 120 and receipt of any first tier payments 130. The financial institution 105 also retains this second set of terms 155 for structuring repayment of the loan 110 by the secondary borrower 140, and, in a fifth step S225 of the embodiment of the loan management method 200 of the present invention depicted in FIG. 2, the financial institution 105 collects second tier payments 145 from the secondary borrower 140 against known installment payment amounts in accordance with the second set of terms 155 and eliminates that responsibility from the purview of the primary borrower 115.

This embodiment of the loan management system 100 for managing more than one loan agreement provides a number of benefits, including a formalized mechanism for repayment of a non-institution loan, such as a person-to-person or small business-to-person loan. Often, these non-institution loans inherently lack any formal mechanism for structuring payments or collecting repayment money. For example, a parent typically lends money to a child out of parental obligation and, more likely, out of concern for their child's needs, such as a need to pay tuition bills. The child in turn often feels indebted to the parent, and often that indebtedness may carry a larger emotional burden than an equal debt owed to an impersonal lending institution with which the child has no preexisting relationship. Alternately, a parent may co-sign for a child and only may learn of a child's default in repayment when contacted by a credit bureau regarding the same.

In these instances, the obligation to repay the parent, however, is without any major financial consequence to the child in the instance of default and the parent typically incurs the debt burden and potential credit damage. Although the child's credit may suffer though because of defaulting on some loan arrangements, the parent generally has no recourse for recouping owed sums. This financial issue in turn could lead to a strained personal relationship should the child default on repaying the parent. This default may result from the child having insufficient income to repay the parent, in which case the terms of repayment likely have been insufficiently devised and probably lack any deferment provision. Also, without a formalized plan for repayment, the child may lack enough structure to budget for repayment successfully, and any money repaid likely lacks any interest charge, which is a standard element of most loan agreements.

To address these and other concerns, the second set of terms 155 formalizes the second loan agreement 150 and establishes a repayment structure for the secondary borrower 140 who is repaying the primary borrower 115. This second set of terms 155 may vary from the first set of terms 125. Accordingly, each installment of second tier payments 145 may differ in principal and interest amounts from each installment of the first tier payments 130. The second set of terms 155 may comprise a unique and distinct schedule of principal and interest payments, and second set of terms 155 may establish a fixed and/or variable repayment interest that is also unique and distinct from the interest rate schedule of the first set of terms 125.

Like the first tier payments 130, each second tier payment 145 may comprise all or part of each scheduled installment amount. The first tier payments 130 and second tier payments 145 then combine to create a self balancing installment loan account 135 for repayment of the single loan 110. In one embodiment, both the first tier payments 130 and second tier payments 145 are directed to the installment loan account 135 at the financial institution 105. The financial institution 105 then may notify the primary borrower 115 immediately of any default in repayment.

In another alternate embodiment, instead of directing second tier payments 145 to the installment loan account 135, the secondary borrower 140 may direct those second tier payments 145 to an escrow account 160 held by the financial institution 105 on behalf of the primary borrower 115. This optional escrow account 160 appears in FIG. 1 in dashed lines to indicate this optional embodiment of the present invention. In the embodiment of the loan management system 100 of the present invention where a secondary borrower 140 directs second tier payments 145 to the escrow account 160, the escrow account 160 may link to the loan account 135 such that the financial institution 105 automatically withdraws funds according to the repayment schedule established by the second set of terms 155.

Turning now to a sixth step S230 of the embodiment of the loan management method 200 of FIG. 2, the financial institution 105 reconciles received combined first tier payments 130 and second tier payments 145 against each corresponding one or more scheduled installment amounts. These first tier payments 130 and second tier payments 145 may be automated payments from existing bank accounts that enable automated reconciling or they may be money manually received and registered at the financial institution 105. In one embodiment, the loan management system 100 of the present invention also may provide payment discrepancy terms 165 for administering any payment deficiency or overpayment of the one or more scheduled installment amounts. Either or both of the first loan agreement 120 and second loan agreement 150 may contain all or some of these discrepancy terms. Alternatively, the financial institution 105 may establish the discrepancy terms 165 and manage the installment loan account 135 accordingly.

These discrepancy terms 165 may stipulate recourse for underpayment by either the primary borrower 115 or the secondary borrower 140, which may include a provision for an Automated Clearing House (ACH) delivery of funds to a primary bank account 170 belonging to the primary borrower 115 from a secondary bank account 170 belonging to the secondary borrower 175. Additionally, the discrepancy terms 165 may address any over payment of funds received from either the primary borrower 115 or the secondary borrower 140 wherein these additional funds may be applied toward the principal owed on the loan 110. Additional monies paid by the secondary borrower 140 on any installment may remain in the escrow account 160 for automated retrieval in the case of a later missed payment or an underpayment. Likewise, the primary borrower 115 may make additional payments to the escrow account 160 so that the financial institution 105 may retain any overpayments on behalf of the primary borrower 115 in lieu of or in addition to accepting accelerated payments from the primary borrower 115 against the principal of the loan 110.

In an alternate embodiment, a third party (not-shown) may collect either or both of the first tier payments 130 and second tier payments 145 on behalf of the financial institution 105. The third party may manage the first set of terms 125 and the second set of terms 155 on behalf of the financial institution. In yet another alternate embodiment, one or more additional lenders may contribute to funding the loan 110. In such an embodiment, additional agreements may exist between the lenders and one lender may act on behalf of all lenders as the financial institution 105 in the presently described embodiments of the invention. In yet another embodiment, more than one primary borrower 115 or more than one secondary borrower 140 may exist in conjunction with repayment of the loan 110. Additional first loan agreements 120 and second loan agreements 150 may exist respectively according to these alternate embodiments of the present invention.

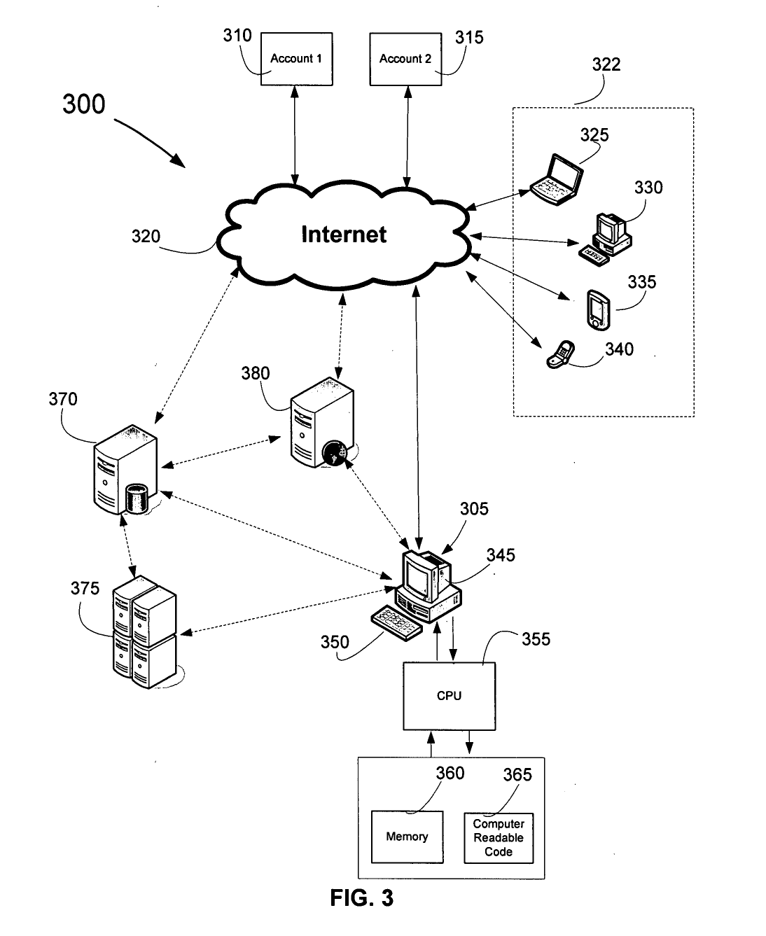

Turning now to FIG. 3, an embodiment of the computer system 300 for implementation of the loan management system 100 of the present invention includes an organization terminal 305 in communication with a plurality of user accounts 310, 315 that are communicating through a computer network. Because the present invention is available on a global level, and because the Internet 320 is a global electronic communications network linking private and public networks and computers, the Internet 320 is an appropriate medium for facilitating the present invention. The plurality of user accounts 310, 315 are preferably accessible from devices capable of communicating with the Internet 130 through wired or wireless means. These user terminals 322 are devices for example such as a laptop computer 325, a stationary computer 330, a personal computing device (PCD) 335, and a cellular telephone 340.

The organization terminal 305 is preferably a computer that comprises elements typical of a computing system. These elements include items such as a monitor 345, a keyboard 350, a processor such as a central processing unit (CPU) 355, and a memory storage area 360. The memory storage area 360 may be random access memory (RAM), or a combination of RAM and some removable memory storage means such as floppy disk, EPROMs, PROMs, or USB storage devices. The memory storage area 360 contains computer readable code, or software 365, for executing the present invention. In an alternative embodiment, the memory storage area 360 may be a database server 370 for an added level of security and more expansive storage capacity. In an alternative embodiment, the organization terminal 305 optionally also may communicate with an application server 375 that stores and executes the software 365 and with a web server 380 that hosts an interactive website that dynamically displays locally relevant information.

Bi-directional routers (not shown) also may be disposed between each of the plurality of user terminals 322 and the Internet 320, and between the Internet 320 and the organization terminal 305. Additionally the laptop computer 325, stationary computer 330, PCD 335, and cellular telephone 340 are shown by way of example only and an unlimited number of user terminals 322 may communicate with the organization terminal 305.

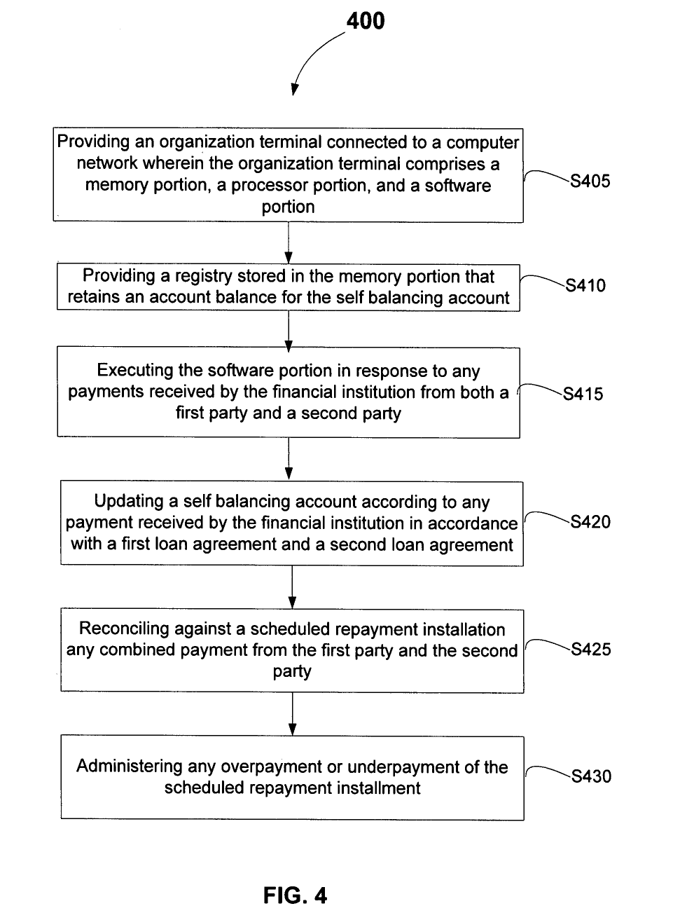

The computer system 300 of FIG. 3 may operate according to a computer implemented method. FIG. 4 depicts an embodiment of such a computer implemented method 400. A first step S405 comprises providing an organization terminal 305 for the financial institution 105 and connecting that organization terminal 305 to a computer network, namely, the Internet 320. The organization terminal 305 comprises a processor portion 355, memory portion 360, and a software portion 365, as described above with relation to FIG. 3. A second step S410 provides a registry stored in the memory portion 355 that retains identification information and balance information for a self balancing loan account 135, which may be an installment loan account. This registry may be a database of information identifying a primary borrower 115 and a secondary borrower 140 associated with the loan account 135.

A third step S415 executes the software portion 365 in response to any first tier payment 130 and/or second tier payment 145 received by the financial institution 105 in repayment of a single loaned sum associated with the loan account 135. The software portion 365 comprises a first, second and third series of executable instructions for processing any first tier payment 130 and/or second tier payment 145 in accordance respectively with the first set of terms, the second set of terms 155 and the discrepancy terms 165. Next, at a fourth step S420, the computer implemented method 400 of FIG. 4 comprises updating a self balancing loan account 135 according to any first tier payment 130 or second tier payment 145 received by the financial institution 105 in accordance respectively with a first loan agreement 120 and a second loan agreement 150. A fifth step S425 then reconciles the combined first tier payment 130 and second tier payments 145 against a scheduled repayment installation for the single loaned sum. At a final step S430, the computer implemented method 400 administers any overpayment or underpayment of the scheduled repayment installment.

At this final step, the organization terminal 305 may retrieve the discrepancy terms 165 as defined by either or both of the first set of terms 125 and second set of terms 155 or by the financial institution 105 which created the loan account 135 for the single loan 110. The organization terminal 305 may process any overpayment by either the primary borrower 115 or the secondary borrower 140 and register that information to the database registry stored either in the memory portion 360 or the database server 370. The primary borrower 115 and secondary borrower 140 may access their loan account 135 and review balances and other typical loan account information. Additionally, information regarding one or more related escrow accounts 160 established on behalf of either or both of the primary borrower 115 or secondary borrower 140 may be available.

Compared to existing systems, this computer network 300 and computer implemented method 400 of managing more than one loan agreement 120, 150 pertaining to a single loan 110 better automates and more accurately manages repayment of a loan 110 by multiple borrowers. In one embodiment, the primary borrower 115 and secondary borrower 140 may establish automatic installment deductions from their respective savings or checking accounts at their individual banks, such as the plurality user accounts 310, 315 depicted in FIG. 3. These accounts 310, 315 are typically accessible through commonly used user terminals 322 having a capability of accessing the Internet 320. Thus, the present invention functions in conjunction with these tools for better automating payments and also for better automating and distributing notifications from the financial institution 105 regarding missed payments or default. The present invention thus provides an improved system and method for managing multiple tiers of loan agreements pertaining to a single loan 110.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

I claim:

1) A method for managing more than one loan agreement pertaining to a single loaned sum repayable in one or more scheduled installment amounts, by a loan originator, the method comprising:
a) providing a first loan agreement between a primary borrower and the loan originator comprising a first set of terms by which the primary borrower makes first tier payments in repayment of the loaned sum, wherein each first tier payment may comprise all or part of the one or more scheduled installment amounts;
b) providing a second loan agreement between the primary borrower and a secondary borrower comprising a second set of terms by which the secondary borrower makes second tier payments to the loan originator in repayment of the loaned sum obtained by the primary borrower and loaned by the primary borrower to the secondary borrower in accordance with the second set of terms,
i. wherein the second tier payments may differ in amount from the first tier payments,
ii. wherein the second set of terms may vary from the first set of terms, and
iii. wherein the second tier payments may comprise all or part of the one or more scheduled installment amounts;
c) loaning the loaned sum to the primary borrower based on the primary borrower's qualifications;
d) administering the first loan agreement and receipt of any first tier payments;
e) administering the second loan agreement and receipt of any second tier payments;
f) reconciling received first tier payments and second tier payments together against each corresponding one or more scheduled installment amounts; and
g) administering any payment deficiency or overpayment of the one or more scheduled installment amounts in accordance with one or more remedies defined within the first set of and/or the second set of terms.

2) The method of claim 1, further comprising the provision of an agreement between the loan originator and a secondary lender for mutual contribution to the loaned sum.

3) The method of claim 1, further comprising the provision of an agreement between the loan originator and a third party administrator for the administration of the first and second tier payments.

4) The method of claim 1, wherein the primary borrower is a person and the first set of terms define an institution-to-person loan agreement.

5) The method of claim 1, wherein the secondary borrower is a person and the second set of terms define a non-institution agreement.

6) The method of claim 5, wherein the primary borrower is a person and the non-institution agreement is a person-to-person loan.

7) The method of claim 5, wherein the primary borrower is a business other than a financial institution and the non-institution agreement is a business-to-person loan.

8) The method of claim 1, wherein the first loan agreement is underwritten based on a primary borrower's credit standing.

9) The method of claim 1, wherein the first set of terms includes a first variable and/or fixed rate of for repayment.

10) The method of claim 9, wherein the second set of terms includes a second variable and/or fixed rate of repayment that may differ from the first variable and/or fixed rate.

11) The method of claim 1, wherein the first set of terms provides for repayment of a federally guaranteed loan.

12) The method of claim 1, wherein the first set of terms provides for repayment of a home equity loan.

13) The method of claim 1, further comprising retaining the second tier payment in an escrow account at the financial institution on behalf of the primary borrower.

14) The method of claim 13, further comprising satisfying any deficient payment of a scheduled installment amount by automatically retrieving second tier payments reserved in the escrow account.

15) A computer-implemented method for managing at least two distinct loan agreements pertaining to repayment of a single institutional loan, thereby establishing a self balancing account for repayment of that institutional loan in scheduled repayment installments, comprising:
a) providing an organization terminal connected to a computer network, wherein the organization terminal comprises a memory portion and a processor portion and wherein the memory portion contains therein a software portion executable by the processor, the software portion further comprising:
i. a first series of executable instructions based on a first set of terms that structures one or more first tier repayments within a first loan agreement between a first party and a financial institution;
ii. a second series of executable instructions based on a second set of terms that structures one or more second tier repayments within a second loan agreement between a second party and the first party, wherein the second tier payments may differ in amount from the first tier payments, wherein the second set of terms may vary from the first set of terms, and wherein the second tier payments may comprise all or part of the one or more scheduled repayment installments;
iii. a third series of executable instructions based on a third set of terms for managing any overpayment or underpayment of any scheduled repayment installment;
b) providing a registry stored in the memory portion that retains an account balance for the self balancing account;
c) executing the software portion in response to any first and second tier repayments received by the financial institution from both the first party and the second party;
d) updating the self balancing account according to any payment received by the financial institution in accordance with the first loan agreement and the second loan agreement;
e) reconciling any combined first tier repayment and the second tier repayment against a scheduled repayment installment; and
f) administering any overpayment or underpayment of the scheduled repayment installment according to the third set of terms.

16) The method of claim 15, wherein the financial institution provides the single institutional loan to the first party based upon the first party's credit.

17) The method of claim 15, wherein the financial institution provides the single institutional loan to the first party based upon the first party's collateral.

18) The method of claim 15, wherein the first party is a person and the first loan agreement is an institution-to-person loan.

19) The method of claim 15, wherein the second loan agreement pertains to a non-institution loan in which the first party loans proceeds from the single institutional loan to the second party, and wherein the financial institution administers that second loan agreement on behalf of the first party, including collecting payments from the second party according to the second set of terms.

20) The method of claim 15, further comprising electronically deducting the first tier and second tier repayments from the first account and the second account respectively, wherein a first account belonging to the first party and a second account belonging to the second party communicate with the organization terminal via the computer network.

21) The method of claim 20, further comprising automatically updating the registry upon receipt of an electronic repayment from each of the first account and the second account.

22) The method of claim 21, further comprising electronically extracting any deficiency in the scheduled repayment installment from the first account belonging to the first party and according to the third set of terms.

23) The method of claim 15, wherein the single institutional loan is a federally guaranteed loan.

24) The method of claim 15, wherein the single institutional loan is a home equity loan.

25) An improved system for managing a single institutional loan originating from a financial institution, comprising:
a) an organization terminal connected to a computer network, wherein the organization terminal comprises a memory portion and a processor portion and wherein the memory portion contains therein a software portion executable by the processor in response to any payments received by the financial institution from at least two parties repaying the single institutional loan;
b) a registry stored in the memory portion that retains an account balance for a single institutional loan repayable by the at least two parties in one or more scheduled repayment installments;
c) a first loan agreement established between a first party and the financial institution that structures first payments to the financial institution in accordance with the one or more scheduled repayment installments and according to a first set of terms that defines a first series of executable instructions within the software portion, wherein the first payments may comprise all or part of a scheduled installment amount;
d) a second loan agreement established between a second party and the first party that structures second payments to the financial institution on behalf of the first party, in accordance with the one or more scheduled repayment installments, and in accordance with a second set of terms that defines a second series of executable instructions within the software portion, wherein the second payments may differ in amount from the first payments, wherein the second set of terms may vary from the first set of terms, and wherein the second payments may comprise all or part of a scheduled installment amount; and
e) a third set of terms that defines a third series of executable instructions within the software portion for managing any overpayment amount or underpayment amount of any scheduled repayment installment pertaining to repayment of the single institutional loan.

26) The system of claim 25, wherein execution of the software portion by the processor portion updates the account balance with any first payments and second payments received by the financial institution in accordance with the first loan agreement and the second loan agreement.

27) The system of claim 25, wherein execution of the software portion calculates any combined payment from the first party and the second party against the one or more scheduled repayment installments.

28) The system of claim 27, wherein execution of the software portion addresses any overpayment or underpayment of the scheduled repayment installment according to the third set of terms.

29) The system of claim 25, wherein the financial institution provides the single institutional loan to the first party and based upon the first party's credit.

30) The system of claim 29, wherein the financial institution provides the single institutional loan to the first party and based upon the first party's collateral.

31) The system of claim 25, wherein the first party is a person and the first loan agreement is an institution-to-person loan.

32) The system of claim 25, wherein the second loan agreement is a non-institution loan in which the first party loans proceeds from the single institutional loan to the second party, and wherein the financial institution administers that second loan agreement on behalf of the first party, including collecting payments from the second party according to the second loan agreement.

33) The system of claim 25, further comprising a first account that is in communication with the organization terminal via the computer network, wherein the first account belongs to the first party, and wherein the organization terminal may communicate with the first account for electronically deducting one or more first payments;

34) The system of claim 33, further comprising a provision among the third set of terms for automatically extracting any deficiency in the scheduled repayment installment from a first account belonging to the first party.

35) The system of claim 25, further comprising a second account that is in communication with the organization terminal via the computer network, wherein the second account belongs to the second party, and wherein the organization terminal may communicate with the second account for electronically deducting a second payment;

36) The system of claim 35, further comprising a provision within the third set of terms for automatically extracting any deficiency in the scheduled repayment installment from a second account belonging to the second party.

37) The system of claim 25, wherein the single institutional loan is a federally guaranteed loan.

38) The system of claim 25, wherein the single institutional loan is a home equity loan.
